(19) United States
(12) Patent Application Publication
(10) Pub. No.: US 2016/0112752 A1
(43) Pub. Date: Apr. 21, 2016

(54) APPARATUS AND METHOD FOR DISPLAYING A PROGRAM GUIDE

(71) Applicants: Vijay SELVARAJ, Folcroft, PA (US); THOMSON LICENSING, Issy Ies Moulineaux (FR)

(72) Inventor: Vijay Anand SELVARAJ, Folcroft, PA (US)

(21) Appl. No.: 14/894,750

(22) PCT Filed: May 29, 2013
(86) PCT No.: PCT/US2013/043074

§ 371 Date: Nov. 30, 2015

(51) Int. Cl. H04N 21/431; H04N 21/462; H04N 21/84; H04N 21/482

(52) U.S. Cl. CPC H04N 21/4312; H04N 21/4821; H04N 21/4622; H04N 21/84; H04N 21/4828

(57) ABSTRACT

A method and apparatus for a generating and displaying a program guide including visual images is described. The method (600) includes receiving (610) text information associated with a plurality of programs, determining (630) at least one visual element associated with a program based on the received text information, and generating (640) a graphical window including the at least one visual element for the program in the subset of the plurality of programs. The apparatus includes a receiver circuit (302) that receives text information associated with a plurality of programs from a media content source, a controller (314) determining at least one visual element associated with a program based on the received text information for the program, and a video processor (310) generating a graphical window, the graphical window including the at least one visual element for the program in the subset of the plurality of programs.

### TECHNICAL FIELD OF THE INVENTION

The present disclosure generally relates to systems that provide media content and further include an electronic program guide associated with the media content. More particularly, the present disclosure is related to an apparatus and method for providing, presenting, and displaying a program guide that includes visual representations of the programs in the program guide.

### BACKGROUND OF THE INVENTION

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Broadcast content service providers and Internet service providers continue to find synergies within their respective content delivery systems. Many networked devices now include the ability to navigate and search through media content based on inherent capabilities from the provider of the media content or service. Networked devices, particularly those devices used in a home, are merging operations and functions associated with broadcast-centric and Internet network-centric devices. These networked devices include televisions, settop boxes, home gateways, home computer media stations, tablets, and the like. These networked devices further offer signal receiving, media recording, home networking, and Internet connectivity capabilities.

Broadcast content service providers often deliver a program guide that includes current and upcoming programming for the various channels in the service. A program guide allows a user to search for and navigate to other programs available from the service provider. The program guide is often downloaded to a user's home network device (e.g., gateway or settop box) through the broadcast network. The program guide contents and program information are then displayed on a display device based on requests from the user.

However, the display of the program guide may not always be visually useful or ideally acceptable to the user. In many cases, the program guide is displayed as a grid of text information showing a list of channels in a vertical direction and a set of time slots in a horizontal direction. Text information about the programs is displayed in boxes in the grid array. These grid based program guides provide only text content related to the programs. In some implementations, the currently viewed program may remain in the display in a small window outside of the program guide grid. Still other implementations may include channel logos for the list of channels. Finally, some guides may provide some form of visual indication of one or more programs in a current time slot. None of these program guide structures address the needs of a user desiring a program guide that enhances the user search and navigation experience by including visual content for the available programs from the service provider. As a result, there is a need for an improvement to the simple text and grid guide based program guide.

### SUMMARY

According to an aspect of the present disclosure, a method for generating and displaying a program guide including visual images is described. The method includes receiving text information associated with a plurality of programs from a media content source, determining at least one visual element associated with a program in a subset of the plurality of programs based on the received text information for the program, and generating a graphical window, the graphical window including the at least one visual element for the program in the subset of the plurality of programs

According to another aspect of the present disclosure, an apparatus for generating and displaying a program guide including visual images is described. The apparatus includes a receiver circuit that receives text information associated with a plurality of programs from a media content source, a controller coupled to the receiver circuit, the controller determining at least one visual element associated with a program in a subset of the plurality of programs based on the received text information for the program, and a video processor coupled to the controller and the receiver circuit, the video processor generating a graphical window, the graphical window including the at least one visual element for the program in the subset of the plurality of programs.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1 is a block diagram of an exemplary system for delivering video content in accordance with the present disclosure;

FIG. 2 is a block diagram of an exemplary home network system in accordance with the present disclosure;

FIG. 3 is a block diagram of an exemplary network device in accordance with the present disclosure;

FIG. 4 is a perspective view of a touch panel device in accordance with the present disclosure;

FIG. 5 is a diagram of an architecture for a portion of operating code for managing and providing a program guide in accordance with the present disclosure;

FIG. 6 is a flowchart of an exemplary process for managing and providing a program guide in accordance with the present disclosure;

FIG. 7 is a diagram illustrating an exemplary view of a user interface including a program guide in accordance with the present disclosure;

FIG. 8 is a illustrating another exemplary view of a user interface including a program guide in accordance with the present disclosure;

FIG. 9 is a illustrating a further exemplary view of a user interface including a program guide in accordance with the present disclosure;

FIG. 10 is a illustrating yet another exemplary view of a user interface including a program guide in accordance with the present disclosure; and

FIG. 11 is a illustrating a still further exemplary view of a user interface including a program guide in accordance with the present disclosure.

It should be understood that the drawing(s) are for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present embodiments address problems associated with effectively managing, providing, and displaying an electronic program guide that includes enhanced visual identification for program content. Program guides may be supplied as part of the broadcast content provided by a media content service provider. Program guides may also be generated as a listing for content that has been recorded and available for playback on a digital video recorder or other device. Program guides may also be generated or provided as a listing for content that is available for delivery from one or more content sources on the Internet.

Conventional program guide displays show the program content for time slots and channels in a grid as text entries. Only minor visual enhancements may be included and may be further limited based on displaying only information provided directly with the program guide information. The lack of visual identifiers for programs may slow or hinder a user's recognition of a program in the guide. Further, the text based guides do not include a simple visual preview mechanism for the programs and do not include the ability to display information about the same or similar program available from alternate sources. The present disclosure addresses these and other shortcomings by allowing programs to be represented visually in one or more different ways and by using information that is acquired separately from the guide information supplied by the service provider as part of the program guide information. These enhancements improve the display and operation of the program guide and further enhance the user experience during program search and navigation in the guide.

The present disclosure describes a program guide display structure that includes visual indicators, such as thumbnails, for identified content listings in the program guide. The enhanced guide presents a visual representation, or thumbnail, that is generated from a standalone video image associated with the program, a program poster, or a still image of a video frame of the program, in the time slot for the program. The entry may also include a text portion overlaid on the thumbnail that provides descriptive text for the program. The program guide information may be provided with the video image or thumbnail already included, or alternately the guide may content may be text based and the video image or thumbnail added by the receiving device after the guide data is received. The visual thumbnails may be determined using information supplied with the program guide data, information that is acquired from other sources, such as the Internet, or from the currently delivered program content. Finally, the user may view a short video preview, such as the program trailer or an already received video clip, or a text box showing alternate sources for one or more program entries in the guide based on a user input while navigating in the program guide.

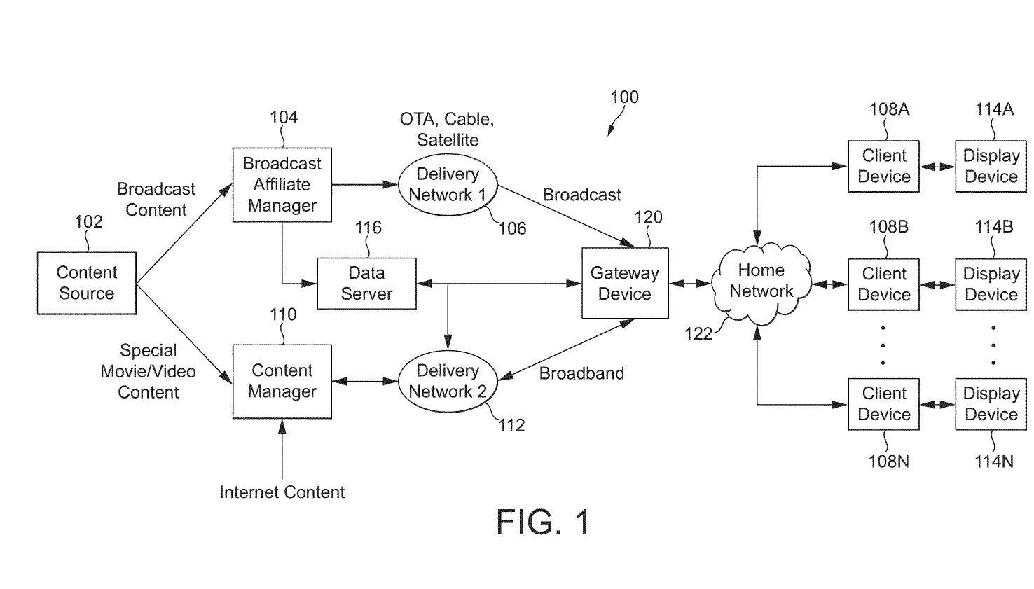

Turning now to FIG. 1, a block diagram of an embodiment of a system 100 for delivering video content to the home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting Systems, now known as CBS Corporation, (CBS), etc. The broadcast affiliate manager 104 may collect and store the content, and may schedule delivery of the content over a delivery network, shown as delivery network 1 (106). Delivery network 1 (106) may include satellite link transmission from a national center to one or more regional or local centers. Delivery network 1 (106) may use any one of the standard transmission protocols and standards for content delivery (e.g., Advanced Television Systems Committee (ATSC) A/53, digital video broadcast (DVB)-Cable (DVB-C), DVB-Satellite (DVB-S), or DVB-Terrestrial (DVB-T)). Broadcast affiliate manager 104 may also create a data stream of program information and provide this information over delivery network 1 (106). This data stream of information may include, but is not limited to, program guide information, data (e.g., text, pictures, video, trailers, audio) associated with programming, delivery or broadcast schedules, or other types of information related to the broadcast content. Delivery network 1 (106) may also include local content delivery using local delivery systems such as over the air broadcast, satellite broadcast, or cable broadcast. The locally delivered content is provided to a gateway device 120 in a user's home. Broadcast affiliate manager 104 may also provide information (e.g., program guide content and other information about programs) to data server 116.

Additional information (e.g., special notices or scheduling information) or other content not provided to the broadcast affiliate manager may be delivered from content source 102 to a content manager 110. The content manager 110 may be a service provider affiliated with a content provider, broadcast service, or delivery network service. The content manager 110 may operate through an Internet website or web service. The content manager 110 may also incorporate Internet content into the delivery system. The content manager 110 may deliver the content to the user's gateway device 120 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Data server 116 receives the information from broadcast affiliate manager 104 and translates the information into a content stream suitable for delivery to a user device (e.g., client device 108). Data server 116 may include a web service for a web site or some networking site. Data server 116 may connect to delivery network 2 (112) to provide the content stream and information to the gateway device 120. Alternatively, data server 116 may include a network interface to a cellular network or other wireless delivery network and provide the content and information in a format compatibility with the wireless network directly to gateway device 120. Additionally, data server 116 may receive information from the Internet through for instance, content manager 110 and delivery network 2 (112). The additional interface permits other content, such as but not limited to information related to programs, supplemental content, and scheduling to be provided to and from data server 116 from sources other than broadcast affiliate manager 104 (e.g., other users, websites, or news agencies).

Gateway device 120 may receive different types of content from one or more of the delivery networks described earlier as well provide messages or information from devices in the user's home back to one or more of the delivery networks. Gateway device 120 processes the content and provides a separation of the content based on instructions provided with the content or over the delivery network. Gateway device 120 may also process and separate content based on instructions received via user commands communicated from client devices 108A-108N through home network 122. Gateway 120 may also provide storage, such as a hard drive or optical disk drive, for recording and/or storing the content as well as providing the content for playback through home network 122. Gateway device 120 may be a settop box, home media server, computer media station, home network gateway, multimedia player, modem, router, home network appliance, or the like.

Gateway device 120 provides the interface between the networks, operating as a wide area network (WAN), and the home network 122, operating as a local area network (LAN). Home network 122 may include both wired and wireless LAN communications. Wired communications may include physical interfaces and wiring for Ethernet, Multimedia over Coaxial cable Alliance (MoCA), or other similar signal formats. Wireless communications may include physical interfaces to accommodate one or more wireless formats including Wi-Fi, Institute of Electrical and Electronics Engineers standard IEEE 802.11 or other similar wireless communications protocols.

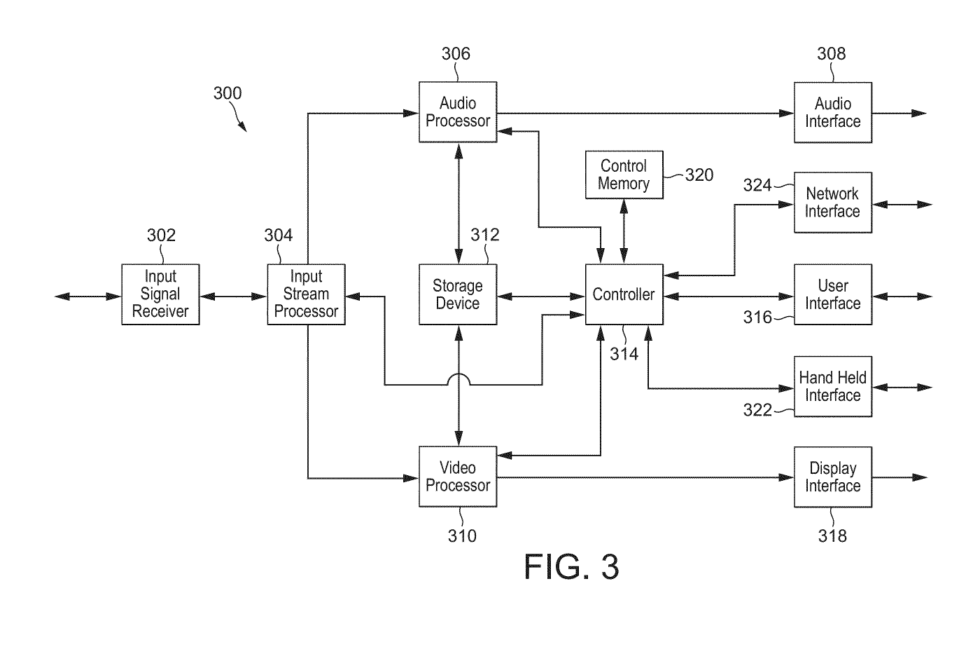

Home network 122 connects the gateway device 120 to client devices 108A-108N at the user's premises. Each of the client devices 108A-108N may include one or both interfaces for wired or wireless communication connection to the home network 122. Client devices 108A-108N may be a cable STB, Internet protocol (IP) STB, or satellite STB. The client devices 108A-108N may also be, but are not limited to, a computer device, tablet, display device, television, wireless phone, personal digital assistant (PDA), computers, gaming platform, remote control, multi-media player, or home networking appliance that includes both broadcast and Internet interfaces, and may further include a storage media for digital video recording. The client devices 108A-108N further process the content from gateway 120 provided through home network 122 and also process and manage user preferences and commands. The client devices 108A-108N may also include a storage device, such as a hard drive or optical disk drive, for recording and playing back audio and video content. Further details of the operation of the client devices 108A-108N and features associated with processing and playing back stored content will be described below in relation to FIG. 3.

The processed content from client devices 108A-108A is provided to display devices 114A-114N. The display devices 114A-114N may be conventional two-dimensional (2-D) type displays or may alternatively be advanced three-dimensional (3-D) type displays. It should be appreciated that other devices having display capabilities including, but not limited to, computer devices, tablets, gateways, display devices, televisions, wireless phones, PDAs, computers, gaming platforms, remote controls, multi-media players, home networking appliances or the like, may employ the teachings of the present disclosure and are considered within the scope of the present disclosure.

It is important to note that any media programs and content as well as any information related to the media programs and content (e.g., program guides, program metadata, visual images, or trailers) may originate at a content source (e.g., content source 102) or at a server device (e.g., server 116). The content and information may be transmitted to a content manager and eventually delivered over either delivery network 1 (106) or delivery network 2 (112) to a user's home (e.g., gateway device 120 and client devices 108A-108N). Alternatively, content and information from the content source may be delivered to a data server, such as data server 116, re-formatted, and then delivered to the user's home. Still further, content and information may originate at the data server (e.g., data server 116) or at a third party source on the Internet and provided to the data server 116 for delivery to the user's home.

In operation, system 100 provides the networking and communication capability for connecting and sharing media content from the WAN between devices on a home network principally through the use of gateway device 120 and client devices 108A-108N. In one embodiment, data associated with programs that has been assembled into a program guide is provided from broadcast affiliate manager 104 to client device 108B through gateway device 120. Gateway device 120 may store the program guide and may also search for and acquire other data (e.g., visual images, video trailers) from another source (e.g., content manager 110 or data server 116) and either store this information, pass on to the client device 108B, or both. At another point in time, the user of client device 108A desires to view the program and may request the guide through a user interface. The guide, along with any additional program guide features or enhancements, is displayed on display device 114A. The enhanced program guide features will be described in further detail below.

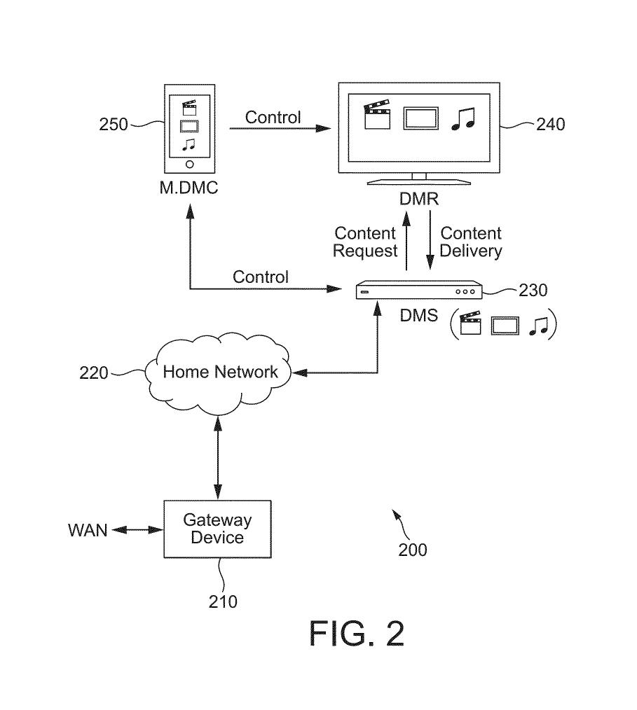

Turning to FIG. 2, a block diagram of a home network system 200 according to aspects of the present disclosure is shown. Home network system 200 operates in a manner similar to the gateway device and the LAN portion of system 100 described in FIG. 1. In particular, home network system 200 operates according to functions associated with the DLNA protocol. In gateway system 200, gateway 210 is interfaced between the WAN and home network 220. Home network 220 is connected to digital media server (DMS) 230. DMS 230 is connected to digital media renderer (DMR) 240. A mobile digital media controller (M-DMC) 250 is coupled to both DMS 230 and DMR 240. It is important to note that home network system 200 represents one possible embodiment of many possible home network systems based on the DLNA protocol or any other similar home network protocol.

Home network system 200 operates as part of a communication network and acts to interface data and media content between the WAN portion of the communication network and one or more devices on a home network. Gateway device 210 provides the interface between the WAN and home network 220. In one embodiment, gateway 202 provides internet protocol (IP) services (e.g., data, voice, video, and/or audio) between a cable, DSL, or satellite WAN and DMS 230. Gateway 210 also provides IP services between DMS 230 and internet destinations identified and connected through the WAN. Gateway device 210 also provides IP voice services between a phone device, such as a M-DMC , and call destinations routed through the WAN.

Home network 220 may include wireless communication capability. A wireless interface may be included in gateway device 210 and may accommodate one or more wireless formats including Wi-Fi, Institute of Electrical and Electronics Engineers standard IEEE 802.11 or other similar wireless communication formats. A similar wireless interface may be included in DMS 230 and may also be included in DMR 240 and M-DMC 250. Home network 220 may also include wired communication capability. A wired communication interface may be included in gateway device 210 and may accommodate one or more wired formats including Ethernet, MoCA, or other similar signal protocols. A similar wired interface may be included in DMS 230 as well as in DMR 240 and M-DMC 250.

Further, both the wired and wireless interfaces and communication formats in home network 220 may support a communication protocol between devices based on the DLNA protocol. DLNA defines interoperability guidelines to enable sharing of digital media content such as music, photos and videos between devices such as computers, TVs, printers, cameras, cell phones, and other multimedia devices. DLNA uses Universal Plug and Play (UPnP) for media management, discovery and control. UPnP defines the type of device that DLNA supports (e.g., “server”, “renderer”, “controller”) and the mechanisms for accessing media over a network. The DLNA guidelines also apply a layer of restrictions over the types of media file formats, encodings and resolutions that a device must support.

DMS 230 interfaces to home network 220 and provides storage and playback capabilities for media content. DMS 230 acts as a DLNA “server” device. DMS 230 may include a user interface as well as the capability to be controlled by an external device, such as M-DMC 250. DMS 230 may also include video and audio conversion processors and functionality. DMS 230 may include a plurality of interface protocols for receiving and delivering media content to other networked devices (e.g., DMR 240 and M-DMC 250). These interface protocols include, but are not limited to DLNA, HDMI, SPDIF, and the like. DMS 230 may be a settop box, a personal computer, a network-attached storage (NAS) device, or the like.

DMR 240 interfaces to DMS 230 and provides video and audio display and reproduction capability. DMR 240 acts as a “renderer” device. DMR 240 may also include a user interface as well as the capability to be controlled by an external device, such as M-DMC 250. DMR 240 may be a television, audio/video receiver, video displays, remote speakers for music, or the like.

M-DMC 250 interfaces to both DMS 230 and DMR 240. M-DMC 250 acts as a “controller” device. Controller devices, such as M-DMC 250 discover and identify content on digital media servers (e.g., DMS 230) through a command and control interface as part of DLNA. M-DMC 250 may also direct the operation of one or more of the devices in the network. In some cases, M-DMC 250 may also provide content to the DMR 240, in addition to providing control for both DMS 230 and DMR 240. M-DMC 250 may be an Internet ready tablet device, Wi-Fi enabled digital camera, mobile cellular phone, advance remote control device, personal digital assistant, or the like.

It is important to note that one or all of the elements described in home network system 200 may be present in the same room or may be present in separate rooms at a user's premises. For example, gateway device 210 and DMS 230 may be located in a utility room, while DMR 240 and M-DMC 250 may be located in a family room. Also, more than one of the elements described in home network system 200 may be present in the user's premises and connected through home network 220 and/or operating using the DLNA protocol. For example, a second DMR 240 may be located in a bed room and operated using M-DMC 250 with content provided through DMS 230.

Further, it is important to note that the functions described for gateway device 210 and DMS 230 may be merged into a single component or transferred and/or shared between components. For example, DMS 230 may include all functionality that is included in a gateway device, such as gateway device 210, and may be used as the interface to the WAN. Other devices, not shown, (e.g., computers, tablets, routers and the like), that are also connected to home network 220 would interface and communicate with DMS 230 in order to interface and communicate to the WAN.

Turning now to FIG. 3, a block diagram of an embodiment of a network device 300 is shown. Except as described below, the network device 300 operates in a manner similar to client devices 108A-108N described in FIG. 1 or to gateway device 210 and/or DMS 230 described in FIG. 2. Network device 300 may also be incorporated into other systems including a display device, such as display devices 114A-114N, or DMR 240. In either case, several components necessary for complete operation of the system are not shown in the interest of conciseness, as the components not shown are well known to those skilled in the art.

Signals are interfaced to network device 300 at input signal receiver 302. Input signal receiver 302 connects to input stream processor 304. The input stream processor 304 connects to audio processor 306 and video processor 310. Audio processor 306 connects to audio interface 308, which provides the audio output signal from network device 300. Video processor 310 connects to display interface 318 which provides the video output signal from network device 300. Audio processor 306 and video processor 310 also connect to a storage device 312. A controller 314 connects to the storage device 312, as well as input stream processor 304, audio processor 306, and video processor 310. A control memory 320 connects to the controller 314. Controller 314 also connects to user interface 316 and handheld interface 322.

Media content (e.g., audio/video programs, program guide information, and program data), as part of signal interfaced with the WAN, is received in an input signal receiver 302. The input signal receiver 302 may be one or more of several known receiver circuits used for receiving, demodulation, and decoding signals provided over one of the several possible networks including over the air, cable, satellite, Ethernet, fiber and phone line networks. It is important to note that input signal receiver 302 may include receiving, demodulation, and decoding circuitry for data signals as well as media content signals delivered over either the same delivery network as the desired broadcast input signal (i.e., delivery network 1 (106)) or over a different network (i.e., delivery network 2 (112)), and/or an alternative cellular or wireless network as described in FIG. 1. The received media content and data over delivery network 2 (112) or wireless network may be different from the received media content and data over delivery network 1 (106). The data may include information associated with scheduling changes and updates as well as information related to the media content delivered over either delivery network. In one embodiment, a cable broadcast signal is received, demodulated, and decoded in a cable tuner circuit in signal receiver 302. The desired broadcast input signal may be selected and retrieved in the input signal receiver 302 based on user input provided through a control interface (not shown). Input signal receiver 302 may also include an Internet protocol (IP) interface circuit that additionally provides bi-directional network connectivity.

The decoded output signal from one or more of the circuits in input signal receiver 302 is provided to an input stream processor 304. The input stream processor 304 performs the final signal selection and processing, and includes separation of video content from audio content for the content stream. The audio content is provided to an audio processor 306 for conversion from the received format (e.g., compressed digital signal) to another format (e.g., analog waveform signal). The analog waveform signal is provided to an audio interface 308 and further to a display device, such as display devices 114A-114N described in FIG. 1 and DMR 240 described in FIG. 2 or an audio amplifier (not shown). Alternatively, the audio interface 308 may provide a digital signal to an audio output device or display device using a High-Definition Multimedia Interface (HDMI) cable or alternate audio interface such as via a Sony/Philips Digital Interconnect Format (SPDIF). The audio processor 206 also performs any necessary conversion for the storage of the audio signals.

The video output from the input stream processor 304 is provided to a video processor 310. The video signal may be one of several formats. The video processor 310 provides, as necessary, a conversion of the video content based on the input signal format. The video processor 310 also performs any necessary conversion for the storage of the video signals.

The network device 300 also includes the ability to receive and process program information (e.g., program guide data) including metadata and images associated with programs (e.g., upcoming program content to be delivered in the future). For example, program guide information sent along with the audio/video content may be received in signal receiver 302 and parsed in input stream processor 304. The information may then be provided to controller 314 for further processing, assembly into a program guide data structure, stored, and provided to display interface 318 as needed. Additionally, other information related to the programs in the guide (e.g., visual thumbnail images, program video trailers or commercials, etc) may be acquired from Internet sources and received in signal receiver 302. The additional program information is parsed in input stream processor 304 and combined with the program data in controller 314. Aspects of program guide processing with visual enhancements will be described in further detail below.

A storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 may be a hard disk drive, one or more large capacity integrated electronic memories, such as static RAM (SRAM), or dynamic RAM (DRAM), an interchangeable optical disk storage system such as a compact disk drive or digital video disk drive, or storage external to, and accessible by, network device 300.

The converted video signal, from the video processor 310, either originating from the input stream processor 304 or from the storage device 312, is provided to the display interface 318. The display interface 318 further provides the display signal to a display device of the type described above. The display interface 318 may be an analog signal interface, such as red-green-blue (RGB), or may be a digital interface (e.g., HDMI).

The controller 314 is interconnected via a bus to several of the components of the network device 300, including the input stream processor 302, audio processor 306, video processor 310, storage device 312, user interface 316, and handheld interface 322. The controller 314 manages the conversion process for converting the input stream signal into a signal for storage on the storage device or for display. The controller 314 also manages the retrieval and playback of stored content. The controller 314 is further coupled to control memory 320 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 314. Control memory 320 may store instructions for controller 314. Control memory 320 may also store a database of elements, such as graphic elements containing content. The database may be stored as a pattern of graphic elements. Alternatively, the control memory 320 may store the graphic elements in identified or grouped memory locations and use an access or location table to identify the memory locations for the various portions of information related to the graphic elements. Additional details related to the storage of the graphic elements will be described below. Further, the implementation of the control memory 320 may include several possible embodiments, such as a single memory device or, alternatively, more than one memory circuit communicatively connected or coupled together to form a shared or common memory. Still further, the control memory 320 may be included with other circuitry, such as portions of bus communications circuitry, in a larger circuit.

In addition to interfacing to a user interface element and a display device, network device 300 may also interface to a handheld device, such as a tablet, through handheld interface 322. This handheld device may include a display screen with additional controls or may include a touch screen. Video signals from video processor 310 as well as other data, such as the on screen display messages and message prompt returns, may be routed between controller 314 and handheld interface 322. Handheld interface 322 may transmit and receive signals and data with a handheld device or tablet using a radio frequency communications link, such as Wi-Fi, Bluetooth, or the IEEE standard 802.11. Handheld interface 322 may alternatively transmit and receive signals and data with a handheld device or tablet using an infra-red interface.

In operation, network device 300 implements a process for the generation and display of the media content that is available for playback in a media device and also implements a process for managing the display of a program guide. Some or all of the program guide data may be delivered as part of the data stream along with audio and video programs from a content service provider (e.g., broadcast affiliate manager 104 described in FIG. 1). Alternatively, some of the program guide data may be acquired or delivered from another source, such as a data server on the Internet (e.g., content manager 110 or data server 116 described in FIG. 1). Still further, images may be extracted from currently received programming. For instance, if the network device 300 is receiving multiple programs simultaneously, then the guide entries for any of these current programs in progress may include a thumbnail still image extracted from the video content for those current programs. The program guide data is processed to separate visual images and video from the text information. If necessary, network device 300 may search for and acquire additional visual data for the programming that is part of the program guide information. Network device 300 generates a display of the program guide using the visual images.

In one embodiment, the program guide is shown as a grid display with channels shown vertically and time slots shown horizontally. Further, a user may move a cursor to one of the time slots for a channel in the grid and network device 300 may provide a video clip for display in the location of the time slot. The video clip may be a portion of a program already received if available, or a video trailer or commercial that has been acquired, received, and stored as part of the guide information. For example when the user is browsing the video thumbnail in the guide, pausing on a particular thumbnail for a few seconds causes the video to play (either with or without audio) in that grid location for the thumbnail. The video clip stops after the user moves the cursor from the time slot. Text information describing the program content may also be overlaid in a portion of the grid box that includes the thumbnail or video clip. Additionally, the box in the grid may expand in size and show additional text information about the program that has been provided with the guide information.

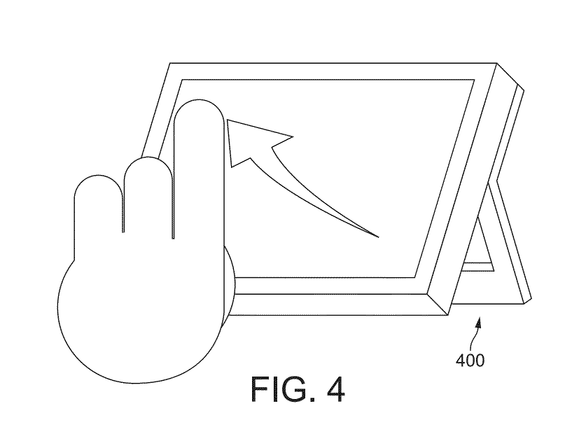

The processes described in the present disclosure may employ an input device that can be used to express functions for searching a database, such as scrolling, browsing, paging, text searching, etc. To allow for this, a touch panel device 400, shown in FIG. 4, may be interfaced via the user interface 316 and/or handheld interface 322 in network device 300, as shown in FIG. 3. The touch panel device 400 may operated in a manner similar to that described for M-DMC 250 in FIG. 2 and permit control of other components in the home network, including DMS 230 and DMR 240. Touch panel device further allows operation of a receiving device or set top box based on hand movements, or gestures, and actions translated through the panel into commands for the device (e.g., network device 300 or client device 108) or other control device. Further, touch panel device 400 may function as a second screen, allowing additional content, such as on screen display windows and messages to be displayed to the user without interrupting or obscuring the viewing of the main display device (e.g., display device 114). In one embodiment, the touch panel device 400 may serve as a navigational tool to navigate the display of an electronic program guide or content display guide. In other embodiments, the touch panel device 400 may additionally serve as the display device allowing the user to more directly interact with the navigation through the grid guide showing display of content. It is important to note that the touch panel device 400 may be integrated into the settop box itself as part of, for instance, a front panel display or array. The touch panel device 400 may also be included as part of a remote control device containing more conventional control functions, such as activator or actuator buttons.

The functioning and control for updating, managing, and providing a program guide for display using a network connected device may be encompassed as part of the operating code or firmware associated with the device (e.g., client devices 108A-108N in FIG. 1, gateway 210 or DMS 230 in FIG. 2 and network device 300 in FIG. 3). The process may include operating instructions written in any programming language (e.g., Java or hypertext markup language (HTML)). The application may be pre-loaded or downloaded (e.g., from a server or Internet site), and stored in a memory of the host device. It is to be appreciated that in one embodiment the instructions are stored in a memory (e.g., control memory 320 in FIG. 3) where the instructions are retrieved thereon and executed by a control circuit (e.g., controller 314). Further, the physical implementation of the algorithm or functions in the process may be done in hardware, such as discrete circuitry related to a video processor (e.g., video processor 310), or software, such as software residing in memory and read and executed by the control circuit. In another embodiment, the memory and a corresponding processor or controller to perform the processing may be integrated into a separate stand-alone integrated circuit (e.g., a digital processing processor (DSP) or an application specific integrated circuit (ASIC)).

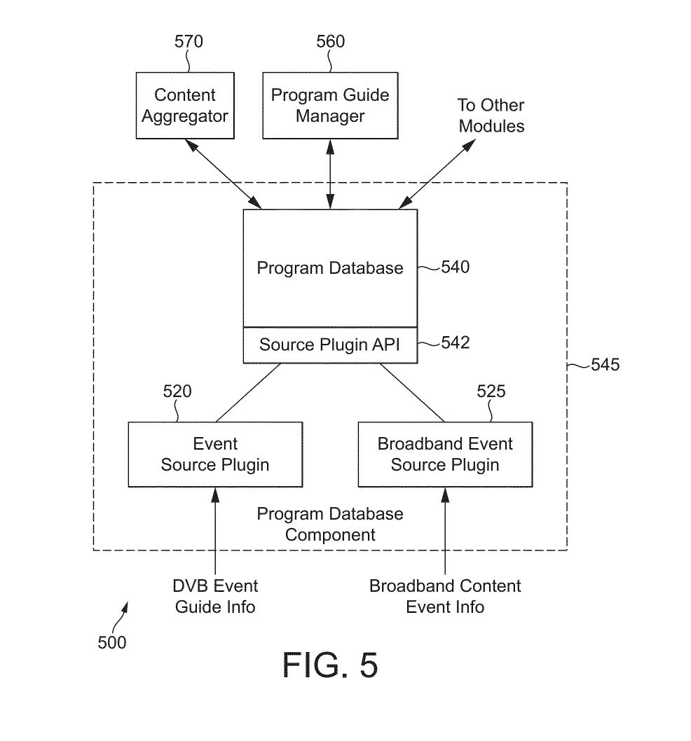

Turning to FIG. 5, a diagram of an exemplary architecture 500 for a portion of operating code used to update, manage, and provide a program guide in a receiving device in accordance with aspects of the present disclosure is shown. Input data from a broadcast source (e.g., broadcast affiliate manager 104 described in FIG. 1) is passed to the broadcast event source plugin 520. Input data from a second source, a broadband content source (e.g., content manager 110 or data server 116 described in FIG. 1), is passed to the broadband event source plugin 525. The broadcast event source plugin 520 and broadband event source plugin 525 interface to the source plugin application programming interface (API) 542. Source plugin API 542 interfaces to program database 540. The program database 540 interfaces to both the program guide manager 560 and content aggregator 570. The source plugin API 542 may also provide for interfaces to other source plugins (not shown). Similarly the program database 540 provides for interfaces to other modules (not shown). Finally, the broadcast event source plugin 520, broadband event source plugin 525, source plugin API 542, and program database 540 are encompassed as a program database component 545.

The program database component 545 provides several services and functions for managing a content database within a device (e.g., network device 300). The program database component 545 provides a persistent storage of event information (e.g., database entries and information) that is retrievable immediately after reboot of the device. The program database component 545 further provides efficient and flexible search interface functionality on event or entry information and criteria. The search functionality may include searching for specific information related to programs (e.g., genre, time slot). The search functionality may also include searching on combinations of criteria. The program database component 545 also provides a flexible interface for providing event or entry information to the program database 540.

The program database 540 is responsible for collecting and providing a searchable interface for event or entry information. The data provided for events (e.g., media content entries) may vary significantly between different service providers and networks. The program database 540 may be designed with a very flexible search input interface and database structure that allows the operating code to accommodate significant variations in event or entry data without specific knowledge of the details of the data being stored. In addition, the inputs to program database 540 are abstracted through source plugin API 542. The program database specifies an interface through the source plugin API 542 for the initial event processing. The source plugin API 542 may not include functions or operations that are exposed to other components (e.g., program guide manager 560 and content aggregrator 570).

Broadcast event source plugin 520 and broadband event source plugin 525 for interfacing event sources are two of several possible shared libraries that can be called directly by program database 540. The broadcast event source plugin 520 provides specific interfacing to the program guide data that is carried within a broadcast signal stream adhering to one of the broadcast standards (e.g., DVB, ATSC, etc). The broadband event source plugin 525 provides specific interfacing to one or more web or Internet based content delivery services. The separate source plugin API 542 is further defined to allow event sources to register with the program database 540 and provide event information. By using a plugin model customizations may be made for a particular service or content provider in the plugin without affecting the rest of program database component 545. The source plugin API 542 also includes interfaces for other source plugins (not shown) to further permit the program database 540 to accommodate event or entry data from multiple sources.

Program database 540 also provides a set of service definitions that allow components (e.g., program guide manager 560 and content aggregator 570) to search and retrieve events or entries and accompanying information. Program guide manager 560 uses information from program database 540 to generate a program guide for display by a display device (e.g., display devices 114A-114N in FIG. 1). The information may include, but is not limited to, text information related to the name, time, and channel for the broadcast of a program, still image thumbnails as a video image associated with the program, a program poster, or a still image of a video frame of the program, a video clip or trailer for the program, and other text information such as episode information and actors. Program guide manager 560 also receives event (e.g., program guide) updates from program database 540 to maintain current status for the program guide. Program guide manager 560 may maintain the various program guide components as part of a database and assemble the guide for display based on a user request. Guide assembly may include creating static video portions for the guide as well as one or more live video windows within the guide. In one embodiment, a grid arrangement for the program guide is provided and a live video window may be created and live video provided for display in one or more program slots within the grid portion of the program guide. Program guide manager 560 may also store one or more video frames for guide content already generated and assembled for display.

Content aggregator 570 gathers and further identifies content that either exists, or is available, from multiple sources interfaced to the device (e.g., network device 300). These sources include any event or program data provided by program database 540. Other sources may include previously recorded content residing on the device, downloaded content residing on the device, and user content residing on a USB stick or the home network. Content aggregator 570 provides a single interface for providing information about all available content. Content aggregator 570 may further interface to other modules or services within the software architecture, including, but not limited to, a digital living network alliance (DLNA) service, a user interface for a local display device, and a remote client running on a tablet.

The process described below includes embodiments that improve the visual identification, use, and user experience for an electronic program guide. The process may be used in various arrangements and program architectures, including architecture 500 described in FIG. 5. Further, the process may be included in various devices, including network device 300, DMS 230, gateway device 120, and client devices 108A-108N described previously. The process relates to generating and providing a thumbnail electronic program guide having video image thumbnails for the programs shown in the guide instead of the text title/description, as is used in many conventional program guides. The thumbnails may represent, for example, the video poster for the program or some still image from the program. The additional visual information may be provided, or may be extracted, either from the guide content or from current programming. For example, if the device is receiving multiple programs simultaneously, the guide display for a current program in progress could include a thumbnail image from those programs. The additional visual information may also be acquired from another source, such as an Internet website.

In addition, when a user is navigating in the program guide, the user may be shown a portion of the program, (e.g., a portion already received if available, or a trailer that is sent and stored as part of the guide) based on a user input (e.g., a pause on a particular thumbnail for several seconds or highlighting the thumbnail). Further, an input from a user may cause the grid box to enlarge or for a second box to be overlaid in a portion of the thumbnail that includes text information describing the program content. For example, a text box may be displayed showing recording program content for the same program series or showing the availability of the program or other related programs from an alternate source (e.g., the broadcast channel website).

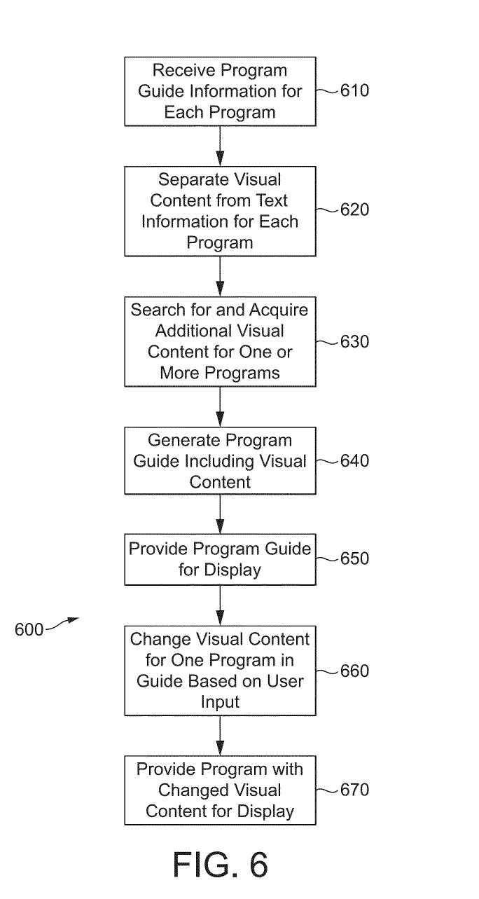

Turning now to FIG. 6 a process 600 for managing and providing a program guide in accordance with the present disclosure is shown. Process 600 described below may be used to improve the operation and user experience when a user accesses a program guide provided by a broadcast service provider. Process 600 will primarily be described with respect to the network device 300 described in FIG. 3. However, one or more of the steps in process 600 may be equally applicable to one or more of the elements described in FIG. 2 or to gateway device 120 and client devices 108A-108N described in FIG. 1. It is important to note that some of the steps described in process 600 may be implemented more than once, or may be implemented recursively. Such modifications may be made without any effect to the overall aspects of process 600.

At step 610, program guide information and other data for program content is received at the input of a receiving device (e.g., input signal receiver 302). Some or all of the program guide data may be delivered as part of the data stream along with audio and video programs from a content service provider, such as broadcast affiliate manager 104 described in FIG. 1. Alternatively, some of the program guide data may be provided from another source, such as a data server on the Internet (e.g., content manager 110 or data server 116 described in FIG. 1).

At step 620, the program guide data is processed to separate visual images and video from the text information. The processing, at step 620, may be performed in input stream processor 304, video processor 310, controller 314, or any combination of the three elements. The video information and visual images may be separately identified from text information. In some embodiments, the processing, at step 620, may include identifying video information and visual images based on the file type or based on some other characteristic of the information that is different from the text information. Next, at step 630, a search may be initiated to acquire additional visual data for the programming that is part of the program guide information. The search, at step 630, may use the text information provided in the program guide data to generate search terms that may be used to search Internet websites or to search a storage device (e.g., storage device 312) for additional visual content related to the programs (e.g., pictures, videos and the like). The text information may include, but is not limited to, the title of the program, the channel the program is delivered from, or the actors in the program.

At step 640, a display is generated that includes a program guide with any visual content (e.g., still images) used for identification of the program content. The visual content may be recovered or acquired from program guide information or from other sources (e.g., storage device or the Internet). In one embodiment, the program guide is generated, at 640, as a grid display in a controller, such as controller 314, with channels shown vertically and time slots shown horizontally. Next, at step 650, the program guide generated at step 640 is provided to a display device for display. The guide is provided, at step 650, through a video processing circuit and display interface (e.g., video processor 310 and display interface 318).

At step 660, a user input may be received and recognized that requests a change to the program guide. The user input may be received through a user interface circuit, such as user interface 316 or handheld interface 322, and further processed in a controller (e.g., controller 314). In response to the user input, at step 660, a change to the content displayed as part of the program guide is generated. At step 670, the change in the program guide may be provided to the video display (e.g., through controller 314, video processor 310, and video interface 318),

In one embodiment, at step 660, the user may move a cursor to one of the time slots for a channel in the grid. In response to the user input, a video clip may be retrieved and provided for display, at step 670, in the location of a time slot in the program guide. The video clip may stop in response to another user input, such as the user moving the cursor from the time slot.

In another embodiment, in response to the user input at step 660, the box in the grid in the program guide may be expanded in size, at step 670. The expanded box may show additional text information about the program that has been provided with the guide information.

In a further embodiment, in response to the user input at step 660, an additional text box may be shown for one of the programs in the guide. The text box may include information about a different episode for the same program that has been recorded. The text box may also include alternate sources for the same program or for different episodes for the same program. The alternate sources may be additional service providers, website content providers, or the website for the channel that is the original source for the program (e.g., content source 102 or broadcast affiliate manager 104 described in FIG. 1).

It is important to note that the steps in process 600 describe only a preferred embodiment. In other embodiments, certain steps in process 600 may be rearranged or may be eliminated. For example, in one embodiment, the search for new content at step 630 may occur before the separation at step 620. Further, although the steps in process 600 are shown as being performed serially, it is possible that one or more of the steps may be performed in parallel. For instance, the separation processing at step 630 and searching at step 640 may be performed at the same time, with the results from these steps leading to the subsequent generation step 640 directly, as described above.

While process 600 is described with respect to a program guide provided through a broadcast service provider, process 600 may equally be used in other embodiments that show content available for viewing. For example, process 600 may be used in a user interface display showing previously recorded content available for viewing in a receiving device. The user interface for display may be in any format including, but not limited to a grid display, a linear display, or a rolling display.

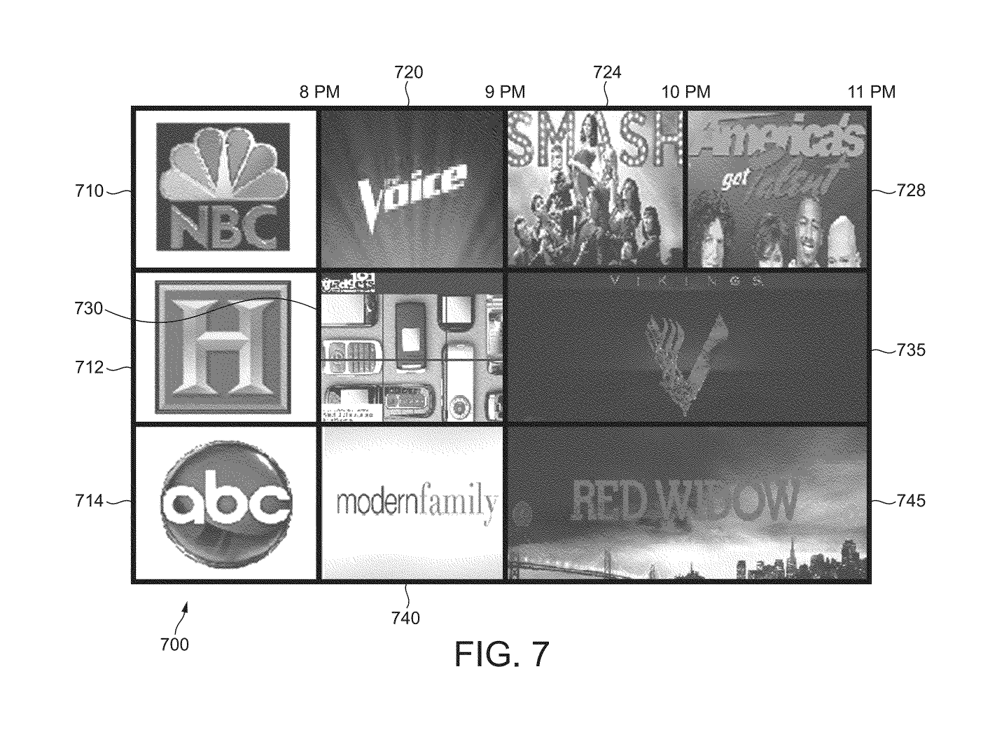

Turning to FIG. 7, a diagram illustrating an exemplary view of a user interface including a program guide 700 in accordance with the present disclosure is shown. Program guide 700 represents an embodiment that includes displaying a received external message and further potentially generating a response message or event that is provided to other users in the group. Program guide 700 is shown as a visual display on a display device, such as one of the display devices 114A-114N described in FIG. 1, and displays content received and processed in a client or host device (e.g., one of client devices 108A-108N described in FIG. 1, gateway 210 or DMS 230 described in FIG. 2, or network device 300 described in FIG. 3).

The display of program guide 700 may be initiated by a user input, such as pressing a button on a remote control. Program guide 700 includes an image of a set of programs that are available now or in the future from a service provider, such as broadcast affiliate manager 104. Program guide 700 is shown as a grid arrangement with time slots shown horizontally and channels shown vertically. Three channels, 710, 712, and 714, are shown. Further, three time slots are shown and identified as time slots 8 PM to 9 PM, 9 PM to 10 PM, and 10 PM to 11 PM. Each of the grids in program guide 700 includes a visual image identifying the program. A first set of visual images are identified as 720, 724, and 728 for channel 710. A second set of visual images are identified as 730 and 735 for channel 712. A third set of visual images are identified as 740 and 745 for channel 714.

It is important to note that the location and/or size of the program guide 700 may be different than as shown. Further, the format and/or aspect ratio of the grid boxes may be modified in order to view more or less information for channels or time slots that are available from the service provider. For instance, the number of channels or time slots display may be more or fewer than the three channels and time slots displayed in program guide 700. Some embodiments, such as program guides for displaying recorded content available for playback, may not include time slots or channel slots and instead show a grid of the programs.

Further, the program guide 700 may remain on the display indefinitely. Alternatively, the program guide 700 may remain on the screen for a predetermined period of time before closing and returning to normal program display (e.g., a ten second time period). Still further, the program guide 700 may be removed from the display screen by an additional user input, such as pushing a button on a remote control device.

Although program guide 700 displays visual images for all programs in all grid locations, some embodiments may not use visual images for programs in all grid locations. For instance, visual images for some programs may not be available, either from the program guide information or for an alternate source, such as the internet. In this case, some grid locations may display text information acquired as part of the received program guide data in place of the visual image. This hybrid guide may be arranged in a grid with some grid locations displaying a visual image for the program and other grid locations displaying text for the program. Further, the additional embodiments described below may be used in grid locations displaying visual images or text.

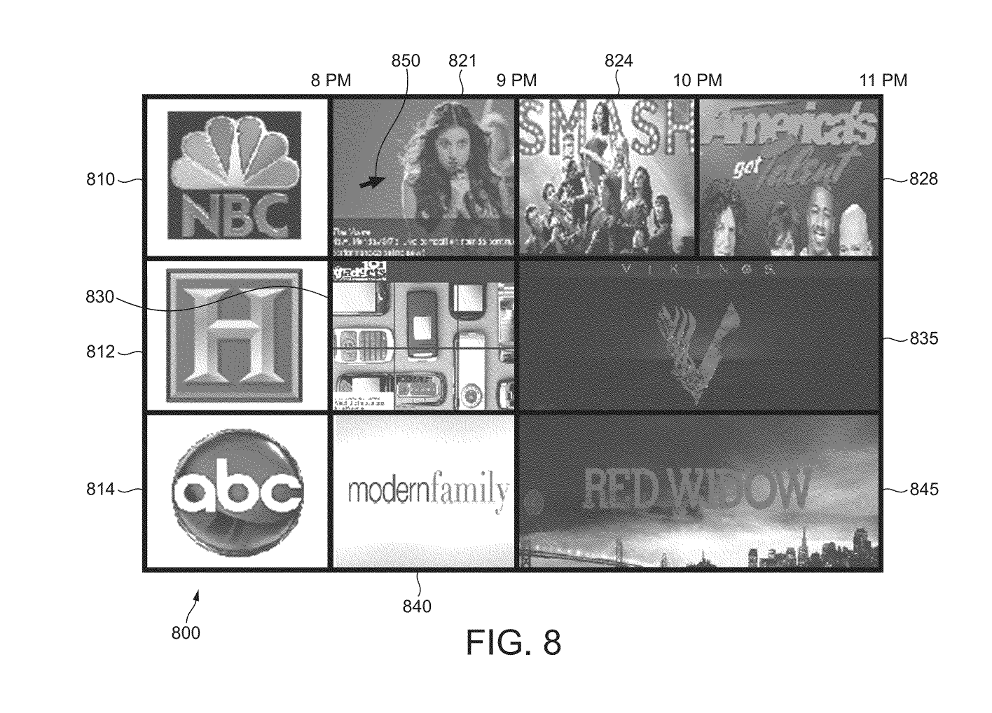

Turning to FIG. 8, a diagram illustrating another exemplary view of a user interface including a program guide 800 in accordance with the present disclosure is shown. Program guide 800 represents an embodiment that includes displaying additional information for a program in a grid time slot in response to an input from a user. The additional information may enhance the operation and visual experience for a user. The additional information may also allow a user to view additional programs or to view portions of the current program that are already in progress. Program guide 800 is similar in appearance to program guide 700 described in FIG. 7. As such, elements 810, 812, 814, 820, 824, 828, 830, 835, 840, and 845 are similar to elements 710, 712, 714, 720, 724, 728, 730, 735, 740, and 745 and will not be further described here.

In program guide 800, a cursor 850 is shown moved to the grid location in the time period 8 PM to 9 PM for channel 810. After the cursor 850 remains in this grid location for a predetermined time period (e.g., two seconds), a video clip 821 begins playing in the grid location. The video clip may be a portion of the program already provided or may be an advertising or other trailer video clip for the program. In addition, a text box may appear below the video clip providing additional information for the program.

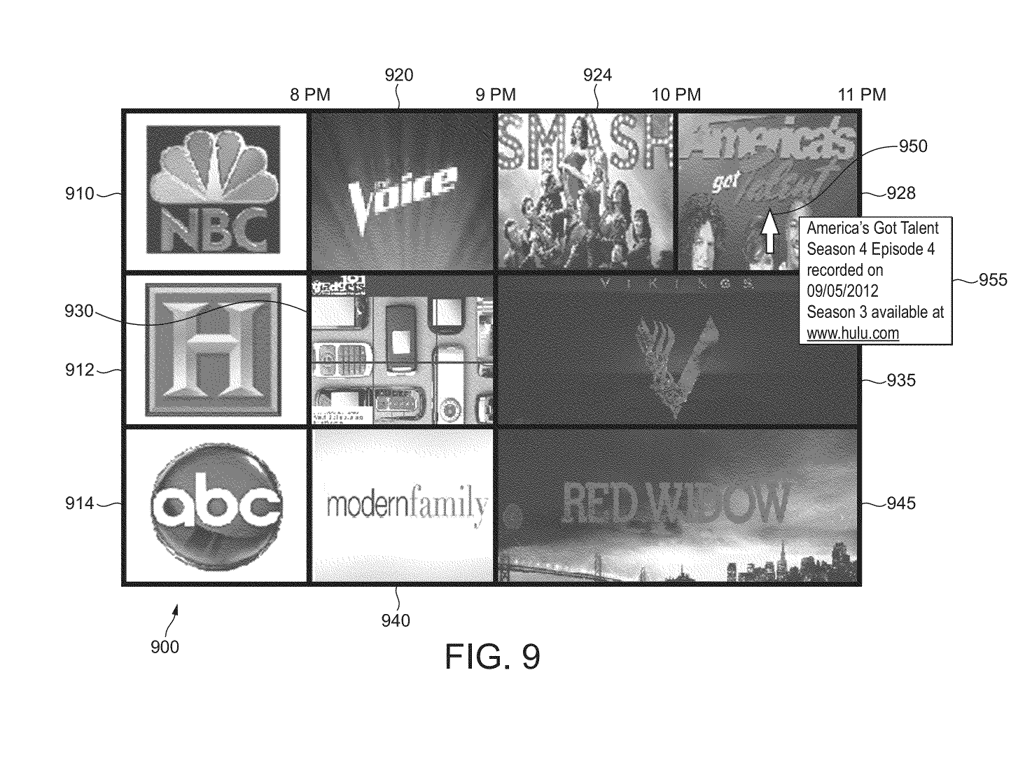

Turning to FIG. 9, a diagram illustrating a further exemplary view of a user interface including a program guide 900 in accordance with the present disclosure is shown. Program guide 900 represents an embodiment that includes displaying additional information for a program in a grid time slot in response to an input from a user. Elements 910, 912, 914, 920, 924, 928, 930, 935, 940, and 945 are similar to elements 710, 712, 714, 720, 724, 728, 730, 735, 740, and 745 and will not be further described here. In program guide 900, a cursor 950 is shown moved to the grid location in the time period 9 PM to 10 PM for channel 910. After the cursor 950 remains in this grid location for a predetermined time period (e.g., two seconds), a text box 955 shown at or near in the grid location 924.

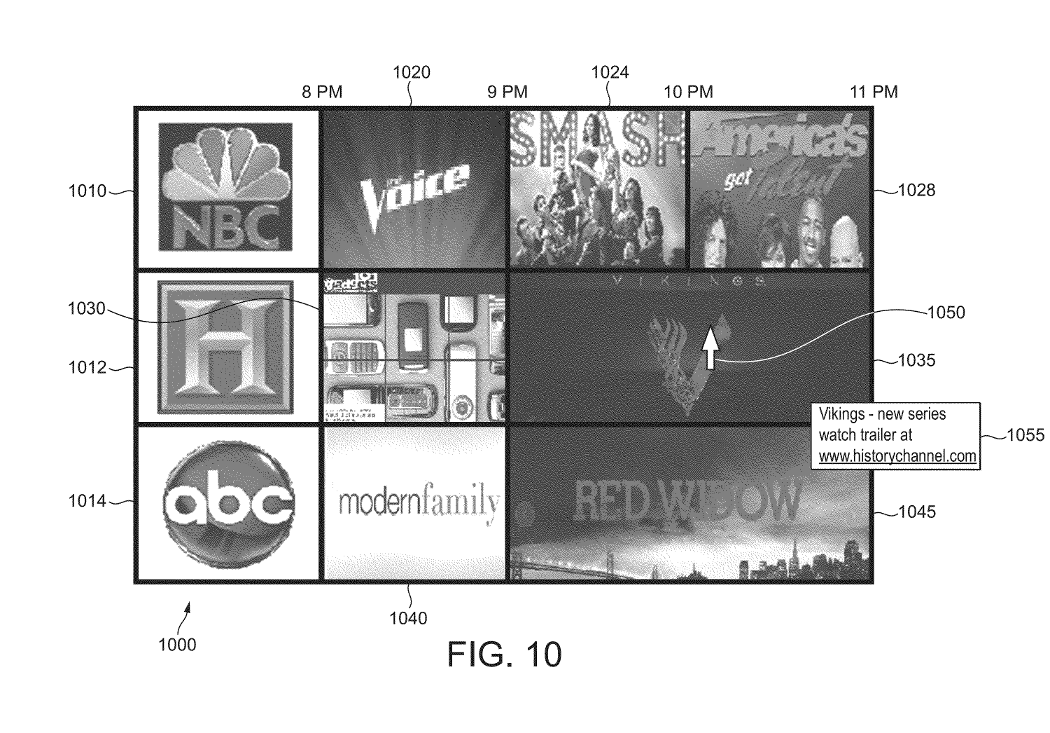

Turning to FIG. 10, a diagram illustrating yet another exemplary view of a user interface including a program guide 1000 in accordance with the present disclosure is shown. Program guide 1000 represents an embodiment that includes displaying additional information for a program in a grid time slot in response to an input from a user. Elements 1010, 1012, 1014, 1020, 1024, 1028, 1030, 1035, 1040, and 1045 are similar to elements 710, 712, 714, 720, 724, 728, 730, 735, 740, and 745 and will not be further described here. In program guide 1000, a cursor 1050 is shown moved to the grid location in the time periods 9 PM to 11 PM for channel 1012. After the cursor 1050 remains in this grid location for a predetermined time period (e.g., two seconds), a text box 1055 shown at or near in the grid location 1035. The text box 1055 indicates that the program is new. The text box 1055 also indicates that a preview for the new program is available from a content source through a website for the content on the Internet.

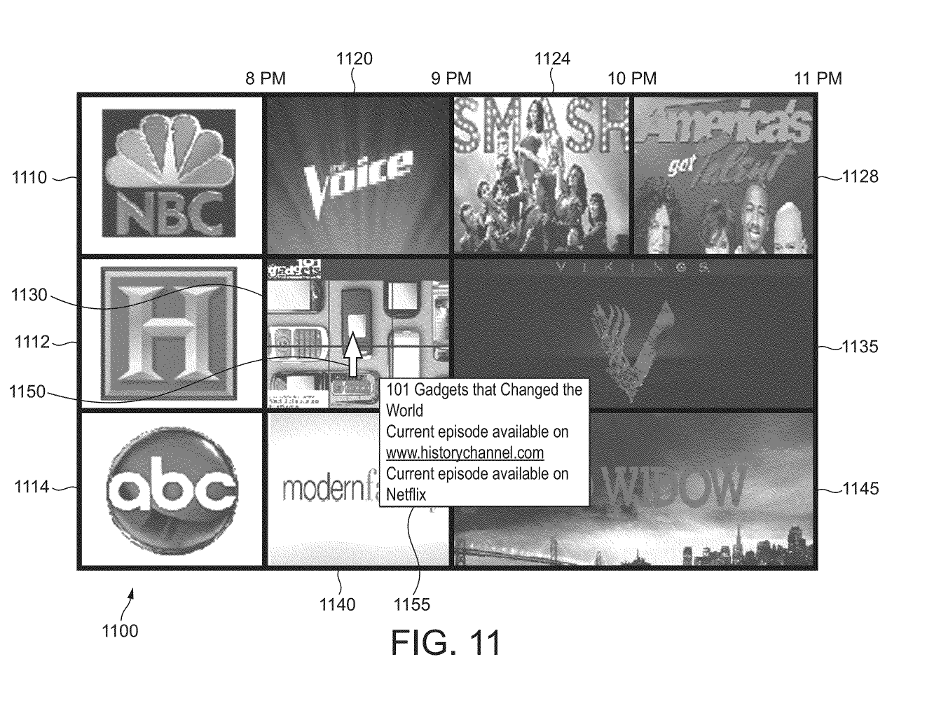

Turning to FIG. 11, a diagram illustrating a still further exemplary view of a user interface including a program guide 1100 in accordance with the present disclosure is shown. Program guide 1100 represents an embodiment that includes displaying additional information for a program in a grid time slot in response to an input from a user. Elements 1110, 1112, 1114, 1120, 1124, 1128, 1130, 1135, 1140, and 1145 are similar to elements 710, 712, 714, 720, 724, 728, 730, 735, 740, and 745 and will not be further described here. In program guide 1100, a cursor 1150 is shown moved to the grid location in the time period 8 PM to 9 PM for channel 1112. After the cursor 1150 remains in this grid location for a predetermined time period (e.g., two seconds), a text box 1155 shown at or near in the grid location 1130. The text box 1155 indicates that the current episode, as well as other episodes, for the program is available from the primary content source through a website for the content on the Internet. The text box 1155 also indicates that all of the episodes are available from an alternate source through a website on the Internet.

Each of the embodiments shown in FIGS. 8-11 may be used and displayed separately or in combination. For example, in response to the user input, a video clip may begin playing and a text box may appear near the video clip displaying further sources for the program or similar programs. Further, the embodiments shown in FIGS. 8-11 may be activated by the same user input or by different user inputs. For example, in one embodiment, the same user input (e.g., hovering over a grid box for a predetermined time period) may activate each of the responses depending on a particular operating mode or the information available for the program. In other embodiments, in addition to a first user input, such as hovering over a grid box, a second user input, such as pressing a button on the user input device, may activate one or more of the embodiments.

The present embodiments address problems associated with effectively managing, providing, and displaying an electronic program guide that includes enhanced visual identification for program content. Conventional program guide displays show the program content for time slots and channels in a grid as text entries. Only minor visual enhancements may be included and may be further limited based on the displaying only information provided directly with the program guide information. The lack of visual clues may slow or hinder a user's recognition of a program in the guide. The embodiments overcome these shortcomings by improving the visual appearance, use and user experience for an electronic program guide. These improvements enhance the display and operation of the program guide and further enhance the user experience during program search and navigation in the guide by providing a thumbnail electronic program guide having video image thumbnails for all the programs shown in the guide instead of the text title/description, as in the conventional program guides. The thumbnails may represent, for example, the video poster for the program or some still image from the program. The additional visual information is provided and extracted, either from the guide content, or from current programming. In addition, when a user is navigating in the program guide, the user may be shown a portion of the program, (e.g., a portion already received if available, or a trailer that is sent and stored as part of the guide) based on a user input (e.g., a pause on a particular thumbnail for several seconds or highlighting the thumbnail. Further, an input from a user may cause the grid box to enlarge, or for text information describing the program content or additional information related to the program to be overlaid in or near a portion of the thumbnail.

The present disclosure describes a program guide display structure that includes visual indicators, such as thumbnails and text boxes, for identified content listings in the program guide. The enhanced guide presents a visual representation, or thumbnail, that is generated from a standalone video image associated with the program, a program poster, or a still image of a video frame of the program, in the time slot for the program. The entry may also include a text portion overlaid on the thumbnail that provides descriptive text for the program. The program guide information may be provided with the video image or thumbnail already included, or alternately the guide may content may be text based and the video image or thumbnail added by the receiving device after the guide data is received. The visual thumbnails may be determined using information supplied with the program guide data, information that is acquired from other sources, such as the Internet, or from the currently delivered program content. Finally, the user may view a short video preview, such as the program trailer or an already received video clip, or additional program related information including alternate sources for one or more program entries in the guide based on a user input while navigating in the program guide.

Although embodiments which incorporate the teachings of the present disclosure have been shown and described in detail herein, those skilled in the art can readily devise many other varied embodiments that still incorporate these teachings. Having described preferred embodiments of a method and apparatus for managing a media content database on a device (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method comprising:
receiving text information associated with a plurality of programs from a media content source;
determining at least one visual element associated with a program in a subset of the plurality of programs based on the received text information for the program, the text information received from a broadcast content service provider, the determining further including searching a database for the visual element based on the received text information for the program, the database being acquired from a source that is different than the broadcast content service provider; and
generating a graphical window, the graphical window including the at least one visual element for the program in the subset of the plurality of programs.

2. The method of claim 1, wherein the text information is received from a broadcast content service provider, and wherein the at least one visual element is acquired from a source that is different than the broadcast content service provider.

3. The method of claim 1, wherein the graphical window that includes the at least one visual element for each program in the subset of the plurality of programs is arranged in a grid.

4. The method of claim 1, wherein the step of determining includes identifying the visual element from the received text information.

5. The method of claim 1, wherein the step of determining includes searching a database for the visual element based on the received text information for the program.

6. The method of claim 1, wherein the visual element is at least one of a thumbnail, a poster image, and a still video image from a portion of the video content for the program.

7. The method of claim 1, further comprising the step of changing the graphical window in response to an input from a user.

8. The method of claim 7, wherein the input from the user include a pointer hovering over one of the at least one visual elements.

9. The method of claim 7, wherein the step of changing the graphical window includes providing a video clip of a portion of video associated with the program.

10. The method of claim 7, wherein the step of changing the graphical window includes enlarging the at least one visual element with respect any other visual elements.

11. The method of claim 7, wherein the step of changing the graphical window includes generating a text box for displaying additional information associated with the program.

12. The method of claim 11, wherein the additional information indicates availability of the program from a media content source other than the current source.

13. The method of claim 12, wherein the media content source other than the content source includes a program recorded on a media content source.

14. An apparatus comprising:
a receiver circuit that receives text information associated with a plurality of programs from a media content source;
a controller coupled to the receiver circuit, the controller determining at least one visual element associated with a program in a subset of the plurality of programs based on the received text information for the program, the text information received from a broadcast content service provider, the controller determining the at least one visual element by searching a database for the visual element based on the received text information for the program, the database being acquired from a source that is different than the broadcast content service provider; and
a video processor coupled to the controller and the receiver circuit, the video processor generating a graphical window, the graphical window including the at least one visual element for the program in the subset of the plurality of programs.

15. The apparatus of claim 14, wherein the text information is received from a broadcast content service provider, and wherein the at least one visual element is acquired from a source that is different than the broadcast content service provider.

16. The apparatus of claim 14, wherein the graphical window includes the at least one visual element for each program in the subset of the plurality of programs are arranged in a grid.

17. The apparatus of claim 14, wherein the controller further identifies the visual element from the received information.

18. The apparatus of claim 14, wherein the controller further searches a database for the visual element based on the received information for the specific program.

19. The apparatus of claim 14, wherein the video processor changes the graphical window in response to an input from the user associated with one of the at least one visual elements for each program in the subset of the plurality of programs.

20. The apparatus of claim 19, wherein the video processor changes the graphical window by at least one of providing a video clip of a portion of video associated with the program, enlarging the visual element with respect to the remaining visual elements, and generating a text box for displaying additional information associated with the program.

21. The apparatus of claim 20, wherein the text box displays availability of the program from a media content source other than the current source.

22. The apparatus of claim 21, wherein the media content source other than the content source includes a program recorded on a media content source.

23. An apparatus comprising:
means for receiving text information associated with a plurality of programs from a media content source;
means for determining at least one visual element associated with a program in a subset of the plurality of programs based on the received text information for the program, the text information received from a broadcast content service provider, the means for determining further including searching a database for the visual element based on the received text information for the program, the database being acquired from a source that is different than the broadcast content service provider; and
means for generating a graphical window, the graphical window including the at least one visual element for the program in the subset of the plurality of programs.

24. The apparatus of claim 23, wherein the graphical window that includes the at least one visual element for each program in the subset of the plurality of programs is arranged in a grid.

25. The apparatus of claim 23, wherein the means for determining includes identifying the visual element from the received text information.

26. The apparatus of claim 23, wherein the visual element is at least one of a thumbnail, a poster image, and a still video image from a portion of the video content for the program.

27. The apparatus of claim 23, further comprising means for changing the graphical window in response to an input from a user.

28. The apparatus of claim 27, wherein the input from the user include a pointer hovering over one of the at least one visual elements.

29. The apparatus of claim 27, wherein the means for changing the graphical window includes providing a video clip of a portion of video associated with the program.

30. The apparatus of claim 27, wherein the means for changing the graphical window includes enlarging the at least one visual element with respect any other visual elements.

31. The apparatus of claim 27, wherein the means for changing the graphical window includes generating a text box for displaying additional information associated with the program.

32. The apparatus of claim 31, wherein the additional information indicates availability of the program from a media content source other than the current source.

33. The apparatus of claim 32, wherein the media content source other than the content source includes a program recorded on a media content source.

34. The apparatus of claim 14, wherein the visual element is at least one of a thumbnail, a poster image, and a still video image from a portion of the video content for the program.

35. The apparatus of claim 19, wherein the input from the user includes a pointer hovering over one of the at least one visual elements.
